(19) United States
(12) Patent Application Publication
(10) Pub. No.: US 2026/0279773 A1
(43) Pub. Date: Sep. 17, 2026

(54) CATHODE ACTIVE MATERIAL AND AN ALL SOLID STATE BATTERY INCLUDING THE SAME

(71) Applicants: HYUNDAI MOTOR COMPANY, Seoul (KR); KIA CORPORATION, Seoul (KR)

(72) Inventors: Je Sik Park, Hwaseong-si (KR); Jeong Hyun Seo, Hwaseong-si (KR); Im Sul Seo, Hwaseong-si (KR); Yong Seok Lee, Hwaseong-si (KR); Joo Young Lee, Hwaseong-si (KR); Hyun Beom Lee, Hwaseong-si (KR); Ju Yeong Seong, Hwaseong-si (KR); Chung Bum Lim, Hwaseong-si (KR)

(73) Assignees: HYUNDAI MOTOR COMPANY, Seoul (KR); KIA CORPORATION, Seoul (KR)

(21) Appl. No.: 19/298,952

(22) Filed: Aug. 13, 2025

(30) Foreign Application Priority Data
Mar. 11, 2025 (KR) 10-2025-0031554

(51) Int. Cl. H01M 4/36; C01G 53/506; H01M 4/485; H01M 4/525

(52) U.S. Cl. CPC H01M 4/366; C01G 53/506; H01M 4/485; H01M 4/525; C01P 2004/03; C01P 2004/61; C01P 2004/80; C01P 2006/12; C01P 2006/16; C01P 2006/40

(57) ABSTRACT

A cathode active material includes a lithium complex metal oxide. The cathode active material is defined by a relative pressure relative to a saturated vapor pressure (P0) of the cathode active material and an adsorption isotherm and a desorption isotherm in a normalized adsorption/desorption amount, where the Normalized adsorption amount=(adsorption amount (cm³/g)/total adsorption amount (cm³/g))×100 and the normalized desorption amount=(desorption amount (cm³/g)/total desorption amount (cm³/g))×100. The maximum adsorption/desorption width (D_{H}) is 0.6 or less, and is expressed as D_{H}=max(Q_{Des}−Q_{Abs}), wherein Q_{Des} is a normalized adsorption amount of the adsorption isotherm, Q_{Abs} is a normalized adsorption amount of the desorption isotherm, and max(Q_{Des}−Q_{Abs}) is the maximum difference value between the normalized adsorption amount of the adsorption isotherm and the normalized adsorption amount of the desorption isotherm, which are calculated based on the same relative pressure.

### CROSS-REFERENCE TO RELATED APPLICATION

This application claims priority to Korean Patent Application No. 10-2025-0031554, filed in the Korean Intellectual Property Office on Mar. 11, 2025, the entire contents of which are incorporated herein by reference.

### TECHNICAL FIELD

The present disclosure provides a cathode active material, capable of controlling a pore characteristic and an all solid state battery including the same.

### BACKGROUND

A secondary battery, which is rechargeable, has been used not only in a smaller electronic device, such as a cellular phone or a laptop computer, but also in larger transportation, such as a hybrid vehicle or an electric vehicle. Accordingly, there is a need to develop a secondary battery having higher stability and energy density

For a conventional secondary battery, a cell is mainly formed based on an organic solvent (or an organic liquid electrolyte). Accordingly, the conventional secondary battery has a limitation in improving stability and an energy density. An all solid state battery employing an inorganic solid electrolyte is based on technology without the organic solvent. Accordingly, the all solid state battery has been spotlighted, as a cell may be manufactured in a stabler and simpler form.

An all solid state battery adds a solid electrolyte to an electrode to move lithium ions. The solid electrolyte may be divided into a sulfide-based solid electrolyte and an oxide-based solid electrolyte. The sulfide-based solid electrolyte having a higher lithium ion conductivity is mainly used. For example, a side reaction is made between the sulfide-based solid electrolyte and the cathode active material, thereby degrading a battery lifespan characteristic.

### SUMMARY

The present disclosure has been made to solve the above-mentioned problems occurring in the prior art while advantages achieved by the prior art maintain intact.

An aspect of the present disclosure provides a cathode active material capable of improving a battery lifespan characteristic, as the content distribution of micro-pores, meso-pores, and macro-pores, and the content of closed pores are controlled.

The technical problems to be solved by the present disclosure are not limited to the aforementioned problems, and any other technical problems not mentioned herein should be clearly understood from the following description by those having ordinary skill in the art to which the present disclosure pertains.

The present disclosure provides a cathode active material including a lithium composite metal oxide. The cathode active material is defined by a relative pressure relative to a saturated vapor pressure (P0) of the cathode active material and an adsorption isotherm and a desorption isotherm in a normalized adsorption/desorption amount graph represented by Equations 1 and 2. The maximum adsorption/desorption width (D_{H}) represented by Equation 3 is 0.6 or less.

$$Normalized adsorption amount = ( adsorption amount ( {cm}^{3} / g ) / total adsorption amount ( {cm}^{3} / g ) ) \times 100 \qquad Equation 1$$

$$Normalized desorption amount = ( desorption amount ( {cm}^{3} / g ) / total desorption amount ( {cm}^{3} / g ) ) \times 100 \qquad Equation 2$$

$${D}_{H} = max ( {Q}_{Des} - {Q}_{Abs} ) \qquad Equation 3$$

wherein Q_{Des} is a normalized adsorption amount of an adsorption isotherm, Q_{Abs} is a normalized adsorption amount of a desorption isotherm, and max(Q_{Des}−Q_{Abs}) indicates a maximum difference value between the normalized adsorption amount of the adsorption isotherm and the normalized adsorption amount of the desorption isotherm, which are calculated based on the same relative pressure.

The present disclosure provides a cathode active material in which a hysteresis defined by the adsorption isotherm and the desorption isotherm is not observed.

The present disclosure provides a cathode active material in which the lithium composite metal oxide include micro-pores having a diameter of less than 2 nm, meso-pores having a diameter in a range of 2 nm to 50 nm, and macro-pores having a diameter greater than 50 nm.

The present disclosure provides a cathode active material in which a pore volume distribution value of pores corresponding to the micro-pore and the meso-pore is smaller than a pore volume distribution value of pores corresponding to the macro-pore.

The present disclosure provides a cathode active material in which a peak is not observed in a graph of the relative pressure and a variation ΔQ_{NA} (%) of the desorption isotherm.

The present disclosure provides a cathode active material including a coating layer surrounding the lithium complex metal oxide wherein the coating layer is boron or LiNbO.

The present disclosure provides a cathode active material having an average diameter in a range of 1 μm to 7 μm.

The present disclosure provides a cathode including the cathode active material.

The present disclosure provides an all solid state battery including the cathode, and further including a solid electrolyte layer, and an anode.

The present disclosure provides an all solid state battery in which the solid electrolyte layer includes a sulfide-based solid electrolyte.

The present disclosure provides the all solid state battery including an anode current collector, an anode active material layer, a cathode active material layer, and a cathode current collector.

The present disclosure provides the all solid state battery where the anode current collector, the anode active material layer, the solid electrolyte layer, the cathode active material layer, and the cathode current collector have a stack structure.

The present disclosure provides the all solid state battery where the anode current collector is Ni, Cu, stainless steel, or any combination thereof.

### BRIEF DESCRIPTION OF THE DRAWINGS

The above and other objects, features and advantages of the present disclosure should be more apparent from the following detailed description taken in conjunction with the accompanying drawings.

FIG. 1 is an SEM image for a cathode active material according to Embodiment 1 of the present disclosure.

FIG. 2 is an SEM image for a cathode active material according to Comparative example 1 of the present disclosure.

FIG. 3 is an SEM image for a cathode active material according to Comparative example 4 of the present disclosure.

FIG. 4 illustrates graphs representing an adsorption isotherm and a desorption isotherm of a cathode active material according to Example 1 to Example 3 of the present disclosure.

FIG. 5 illustrates graphs representing an adsorption isotherm and a desorption isotherm of a cathode active material according to Comparative example 1 to Comparative example 4 of the present disclosure.

FIG. 6 illustrates graphs representing a pore volume distribution as a function of a pore diameter of a cathode active material according to Example 1 to Example 3 of the present disclosure.

FIG. 7 illustrates graphs representing a pore volume distribution as a function of a pore diameter of a cathode active material according to Comparative example 1 to Comparative example 4 of the present disclosure.

FIG. 8 illustrates graphs representing a variation ΔQ_{NA} of a desorption isotherm as a function of a relative pressure of a cathode active material according to Example 1 to Example 3 of the present disclosure.

FIG. 9 illustrates graphs representing a variation ΔQ_{NA} of a desorption isotherm as a function of a relative pressure of a cathode active material according to Comparative example 1 to Comparative example 4 of the present disclosure.

FIG. 10 is a graph representing a capacity retention (%) per cycle of an all solid state battery including a cathode active material according to Examples and comparative examples of the present disclosure.

### DETAILED DESCRIPTION

Hereinafter, the present disclosure is described in more detail for the understanding of the present disclosure. For example, terms or words used in the present specification and the claims should not be interpreted as commonly-used dictionary meanings, but be interpreted as to be relevant to the technical scope of the present disclosure based on the fact that the inventor may properly define the concept of the terms to explain the present disclosure in best ways.

In the present disclosure, the term ‘primary particle’ refers to a minimum particle unit distinguishable as one lump, when a cross-section of the cathode active material is observed through scanning electron microscope (SEM), and may include a plurality of crystal gains.

In the present disclosure, the term ‘secondary particle’ refers to a secondary structure formed as a plurality of primary particles are cohered. The average particle diameter of the secondary particle may be measured through a particle size analyzer.

In the present disclosure, the ‘average diameter (D₅₀)’ refers to a particle diameter corresponding to a point of 50% in a cumulative volume distribution based on a particle diameter. The average diameter may be measured by dispersing powders into a dispersion medium, by introducing a particle size measuring device (for example, S3500 by Microtrac), which is commercially available, to measure the difference in diffraction pattern between particles, depending on particle sizes in the measuring device when the particles pass through a laser beam, thereby measuring particle distribution, and by calculating a particle diameter at a point of 50% in a cumulative volume distribution depending on the particles.

### Cathode Active Material

The present disclosure provides a cathode active material.

According to an embodiment of the present disclosure, the cathode active material at least includes lithium complex metal oxide particles. The cathode active material is defined by a relative pressure relative to a saturated vapor pressure (P0) of the cathode active material and an adsorption isotherm and a desorption isotherm in a normalized adsorption/desorption amount graph represented by Equations 1 and 2. For example, the maximum adsorption/desorption width (D_{H}) represented by Equation 3 is 0.6 or less.

$$Normalized adsorption amount = ( adsorption amount ( {cm}^{3} / g ) / total adsorption amount ( {cm}^{3} / g ) ) \times 100 \qquad Equation 1$$

$$Normalized desorption amount = ( desorption amount ( {cm}^{3} / g ) / total desorption amount ( {cm}^{3} / g ) ) \times 100 \qquad Equation 2$$

$${D}_{H} = max ( {Q}_{Des} - {Q}_{Abs} ) , \qquad Equation 3$$

wherein Q_{Des} is a normalized adsorption amount of the adsorption isotherm, Q_{Abs} is a normalized adsorption amount of the desorption isotherm, and max (Q_{Des}−Q_{Abs}) is a maximum difference value between the normalized adsorption amount of the adsorption isotherm and the normalized adsorption amount of the desorption isotherm, which are calculated based on the same relative pressure.

The all solid state battery employs a sulfide-based solid electrolyte having a higher lithium ion conductivity as a solid electrolyte. For example, the sulfide-based solid electrolyte forms a solid interface with the cathode active material by physically making contact with the cathode active material, which is different from a liquid electrolyte. Accordingly, when fine pores are present in a surface of the cathode active material, a path for moving ions or electrons may be lost, thereby degrading a battery lifespan characteristic.

According to an embodiment of the present disclosure, in the cathode active material, the content distribution of micro-pores, meso-pores, and macro-pores and the content of closed pores may be controlled. Accordingly, even if the side reaction with the sulfide-based solid electrolyte is made, the path for moving electrons and ions may be prevented from being lost inside the cathode active material, thereby improving the battery lifespan characteristic.

Hereinafter, the cathode active material is described in detail according to an embodiment of the present disclosure.

According to an embodiment of the present disclosure, the cathode active material, which allows lithium ions (Li+) to be reversibly intercalated or deintercalated, may include a composite oxide (or a lithium complex metal oxide) of lithium and metal.

According to an embodiment of the present disclosure, the lithium complex metal oxide may be a lithium-manganese-based oxide (e.g., LiMnO₂ or LiMn₂O₄), a lithium-cobalt-based oxide (e.g., LiCoO₂), a lithium-nickel-based oxide (e.g., LiNiO₂), a lithium-nickel-manganese-based oxide (e.g., LiNi_{1-Y}Mn_{Y}O₂ (0<Y<1) or LiMn_{2-z}Ni_{z}O₄ (0<Z<2)), a lithium-nickel-cobalt-based oxide (e.g., LiNi_{1-Y1}Co_{Y1}O₂ (0<Y1<1)), a lithium-manganese-cobalt-based oxide (e.g., LiCo_{1-Y2}Mn_{Y2}O₂ (0<Y2<1), or LiMn_{2-z1}Co_{z1}O₄ (0<Z1<2)), a lithium-nickel-manganese-cobalt-based oxide (e.g., Li(NiₚCo_{q}Mnᵣ₁)O₂ (0<p<1, 0<q<1, 0<r1<1, and p+q+r1=1) or Li(Niₚ₁Co_{q1}Mnᵣ₂)O₄ (0<p1<2, 0<q1<2, 0<r2<2, and p1+q1+r2=2)), or a lithium-nickel-cobalt-transition metal (M) oxide (e.g., Li(Niₚ₂Co_{q2}Mnᵣ₃M_{S2})O₂ (M is Al, Fe, V, Cr, Ti, Ta, Mg, Mo, or any combination thereof; p2, q2, r3 and s2 are atomic fractions of independent elements; 0<p2<1, 0<q2<1, 0<r3<1, 0<s2<1, p2+q2+r3+s2=1)), or may include any one or at least two of the above materials.

The lithium complex metal oxide may be LiCoO₂, LiMnO₂, LiNiO₂, a lithium nickel manganese cobalt oxide (e.g., Li(Ni_{1/3}Mn_{1/3}Co_{1/3})O₂, Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂ or Li(Ni_{0.8}Mn_{0.1}Co_{0.1})O₂), or a lithium nickel cobalt aluminum oxide (e.g., Li(Ni_{0.8}Co_{0.15}Al_{0.05})O₂) to enhance a capacity characteristic and stability of a battery. When considering an effect remarkably improved by controlling the type and content ratio of components forming the lithium complex metal oxide, the lithium nickel manganese cobalt oxide may be Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂, or Li(Ni_{0.8}Mn_{0.1}Co_{0.1})O₂, or may employ any one of the above materials, or a mixture of at least two of the above materials.

According to an embodiment of the present disclosure, the cathode active material may further include a coating layer to surround the lithium complex metal oxide. The coating layer may include boron (B) and LiNbO. As the coating layer is further included, the structural stability of the cathode active material may be improved.

According to an embodiment of the present disclosure, pores may be formed in the lithium complex metal oxide, and the types of the pores may be classified depending on diameter sizes. The pores may be classified into micro-pores having a diameter of less than 2 nm, meso-pores having a diameter in a range from 2 nm to 50 nm, and macro-pores having a diameter greater than 50 nm.

According to an embodiment of the present disclosure, the lithium complex metal oxide may include micro-pores, meso-pores, and macro-pores which are properly controlled in content distribution. Accordingly, the path for moving electrons and ions may be prevented from being lost inside the cathode active material, thereby improving the battery lifespan characteristic.

According to an embodiment of the present disclosure, in the cathode active material, the content distribution of the meso-pores of the lithium complex metal oxide is controlled. Accordingly, the cathode active material is defined by a relative pressure relative to a saturated vapor pressure (P₀) of the cathode active material and an adsorption isotherm and a desorption isotherm in a normalized adsorption/desorption amount graph represented by Equations 1 and 2. For example, the maximum adsorption/desorption width (D_{H}) represented by Equation 3 is 0.6 or less.

The maximum adsorption/desorption width (D_{H}) may be at most 0.55, at most 0.5, at most 0.45, at most 0.4, at most 0.35, or at most 0.3, and may be at least 0.005, at least 0.01, at least 0.015, at least 0.02, or at least 0.03. When the above range is satisfied, as the content distribution of the meso-pores of the lithium complex metal oxide is properly controlled, the path for moving electrons and ions may be prevented from being lost inside the cathode active material, thereby improving the battery lifespan characteristic. When the maximum adsorption/desorption width (D_{H}) exceeds the above range, the content distribution of the meso-pores of the lithium complex metal oxide is excessively increased to increasingly form a degradation layer by a side reaction with the solid electrolyte, thereby degrading the battery lifespan characteristic.

According to an embodiment of the present disclosure, in the cathode active material, the proportions of the micro-pores and meso-pores and the proportion of the macro-pores in the lithium complex metal oxide are properly controlled. Accordingly, in the graph of a pore volume distribution as a function of a pore diameter with respect to the cathode active material, a pore volume distribution value of pores corresponding to the micro-pores and the meso-pores may be less than a pore volume distribution value of pores corresponding to the macro-pores. For example, the pore volume distribution may be defined through following Equation 4.

$$pore volume distribution = \frac{dV}{d log ( D )} \qquad Equation 4$$

In Equation 4, d log(D) is a minute change in the log value of the pore diameter (D), and dV is a minute volume change of the pores corresponding to the pore diameter (D).

According to an embodiment of the present disclosure, in the graph of the pore volume distribution as function of the pore diameter with respect to the cathode active material, all pore volume distribution values in a section having a pore diameter of at most 50 nm may be less than all pore volume distribution values in a section having a pore diameter of greater than 50 nm. In addition, according to an embodiment of the present disclosure, in the graph of the pore volume distribution as a function of the pore diameter with respect to the cathode active material, the pore volume distribution values in the section having the pore diameter of greater than 50 nm is mainly upward to the right. As a graph outline described above is formed, the proportions of the micro-pores and the meso-pores and the proportion of the macro-pores in the lithium complex metal oxide may be properly controlled, so the path for moving electrons and ions are prevented from being lost inside the cathode active material, thereby improving the battery lifespan characteristic. For a lithium complex metal oxide in which a pore volume distribution value greater than any pore volume distribution value in the section having the pore diameter of greater than 50 nm is present among the pore volume distribution values in the section having the pore diameter of at most 50 nm, the proportions of the micro-pores and meso-pores are higher, as compared to the lithium complex metal oxide, in which the proportions of the micro-pores and the meso-pores properly and the proportion of the macro-pores are properly controlled. Accordingly, the degradation layer by the side reaction with the solid electrolyte is increasingly formed to degrade the battery lifespan characteristic.

According to an embodiment of the present disclosure, the content distribution of micro-pores, meso-pores, and macro-pores in the lithium complex metal oxide may be controlled by adjusting a sintering temperature, a sintering time, a precursor shape, a dopant (e.g., Ti, W, Mo, Zr, Ta, or Nb), or surface coating when the cathode active material is prepared.

According to an embodiment of the present disclosure, the types of the pores may be classified depending on the shape of the pores. The pores may be classified into closed pores or open pores depending on the shape of the pore. According to the present disclosure, the closed pore may be understood as a concept including an independent pore which has pore wall surfaces closed without being linked to another pore or the outside. In addition, the closed pore may be understood as a concept including a pore having an entrance for introducing or withdrawing substances from the outside, as some of the wall surfaces are not closed, in which the entrance has a width narrower than a width of an inner part of the pore. In addition, the open pore may refer to a pore except for the closed pore. The open pore may have an entrance for introducing or withdrawing substances from the outside, as some of wall surfaces of the pore are not closed.

According to an embodiment of the present disclosure, the lithium complex metal oxide may include closed pores properly controlled in content. Accordingly, the path for moving electrons and ions may be prevented from being lost inside the cathode active material, thereby improving the battery lifespan characteristic.

According to an embodiment of the present disclosure, as the content of the closed pores in the lithium complex metal oxide is properly controlled, the cathode active material has no peak realized in a graph representing a variation ΔQ_{NA} (%) of a desorption isotherm as a function of a relative pressure.

According to an embodiment of the present disclosure, the peak has an intensity of at least 0.2% in the graph representing the variation ΔQ_{NA} (%) of the desorption isotherm as the function of the relative pressure. The peak may refer to a peak having the intensity of at least 0.22%, at least 0.24%, at least 0.26%, at least 0.28%, at least 0.3%, at least 0.32%, at least 0.34%, at least 0.36%, at least 0.38%, or at least 0.4%. When the peak having the intensity in the above range in the graph representing the variation ΔQ_{NA} (%) of the desorption isotherm as the function of the relative pressure, is observed, the content of closed pores exceeds a proper range. Accordingly, the degradation layer by the side reaction with the solid electrolyte is increasingly formed to degrade the battery lifespan characteristic.

According to an embodiment of the present disclosure, the content of closed pores in the lithium complex metal oxide may be controlled by adjusting a sintering temperature, a sintering time, a precursor shape, a dopant (e.g., Ti, W, Mo, Zr, Ta, or Nb), or surface coating when the cathode active material is prepared.

According to an embodiment of the present disclosure, the cathode active material may have the average diameter (D₅₀) in a range from 1 μm to 7 μm. The average diameter (D₅₀) may have the thickness of at least 1.2 μm, at least 1.4 μm, at least 1.6 μm, at least 1.8 μm, or at least 2 μm, and may be at most 6.8 μm, at most 6.6 μm, at most 6.4 μm, at most 6.2 μm, or 6 μm. When the above range is satisfied, the path for moving electrons and ions may be more easily prevented from being lost inside the cathode active material.

According to an embodiment of the present disclosure, the cathode active material may have a BET specific surface area of at most 0.6 m²/g. The BET specific surface area may be at most 0.58 m²/g, at most 0.56 m²/g, at most 0.54 m²/g, at most 0.52 m²/g, or at most 0.5 m²/g, and may be at least 0.2 m²/g, at least 0.22 m²/g, at least 0.24 m²/g, at least 0.26 m²/g, at least 0.28 m²/g, or at least 0.3 m²/g. When the above range is satisfied, the path for moving electrons and ions may be more easily prevented from being lost inside the cathode active material.

### All Solid State Battery

The present disclosure provides an all solid state battery including the cathode active material.

According to an embodiment of the present disclosure, the all solid state battery may have a stack structure of an anode current collector, an anode active material layer, a solid electrolyte layer, a cathode active material layer, and a cathode current collector.

According to an embodiment of the present disclosure, the anode current collector may be a base provided in the form of a plate having an electrical conductivity. The anode current collector may have the form of a sheet, a thin film, or a foil.

According to an embodiment of the present disclosure, the anode current collector may be a material which does not react with lithium. The anode current collector may include Ni, Cu, stainless steel (SUS), or any combination thereof.

According to an embodiment of the present disclosure, the anode active material layer may include the anode active material, the solid electrolyte, and the binder.

According to an embodiment of the present disclosure, the anode active material is not specifically limited thereto. For example, the anode active material may include a carbon active material and a metal active material.

According to an embodiment of the present disclosure, the carbon active material may be graphite, such as mesocarbon microbeads (MCMB) and highly oriented graphite (HOPG), or amorphous carbon such as hard carbon, and soft carbon.

According to an embodiment of the present disclosure, the metal active material may be In, Al, Si, Sn, or an alloy containing at least one element of In, Al, Si, or Sn.

According to an embodiment of the present disclosure, the solid electrolyte may be an oxide-based solid electrolyte or a sulfide-based solid electrolyte. It may be advantageous that the solid electrolyte may include the sulfide-based solid electrolyte having a higher lithium ion conductivity. The details of the sulfide-based solid electrolyte have been described above. Accordingly, the details thereof have been omitted below.

According to an embodiment of the present disclosure, the conductive material is a component to form an electron transferring path within the electrode. The conductive material may be a sp2 carbon material, such as carbon black, conducting graphite, ethylene black, and carbon nanotube, or graphene.

According to an embodiment of the present disclosure, the binder may include butadiene rubber (BR), nitrile butadiene rubber (NBR), hydrogenated nitrile butadiene rubber (HNBR), polyvinylidene difluoride (PVDF), polytetrafluoroethylene (PTFE), or carboxymethylcellulose (CMC).

According to an embodiment of the present disclosure, the solid electrolyte layer, which is a component to transfer a lithium ion between the cathode and the anode, may include a solid electrolyte having lithium ion conductivity. The solid electrolyte includes an oxide-based solid electrolyte, a sulfide-based solid electrolyte, a polymer electrolyte, or a combination thereof, and may include a sulfide-based solid electrolyte.

According to an embodiment of the present disclosure, the sulfide-based solid electrolyte may include Li₆PS₅X (X=Cl, Br or I), Li₁₀GeP₂S₁₂, Li₃PS₄, Li₇P₃Sn₁₁, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which ‘m’ and ‘n’ are positive numbers; Z is Ge, Zn, or Ga), Li₂S—GeS₂, Li₂S—SiS₂—Li₃PO₄, Li₂S—SiS₂—LiₓMO_{y} (in which ‘x’ and ‘y’ are positive numbers; M is P, Si, Ge, B, Al, Ga, or In), or a combination thereof.

According to an embodiment of the present disclosure, the cathode active material layer may include the cathode active material, the solid electrolyte, the conductive material, and the binder. The details of the cathode active material have been described above. Accordingly, the details thereof have been omitted below.

According to an embodiment of the present disclosure, the solid electrolyte may be an oxide-based solid electrolyte or a sulfide-based solid electrolyte. It may be advantageous that the solid electrolyte may include the sulfide-based solid electrolyte having a higher lithium ion conductivity.

According to an embodiment of the present disclosure, the conductive material and the binder have been described above, and the details thereof have been omitted below.

According to an embodiment of the present disclosure, the cathode current collector may be a base provided in the form of a plate having an electrical conductivity. The cathode current collector may have the form of a sheet, a thin film, or a foil.

According to an embodiment of the present disclosure, the cathode current collector may include indium, copper, magnesium, aluminum, stainless steel, iron, or any combination thereof

According to an embodiment of the present disclosure, the solid electrolyte free-standing film is positioned between the anode active material layer and the cathode active material layer to transfer a lithium ion.

Hereinafter, an embodiment of the present disclosure is described in detail such that those having ordinary skill in the art may easily reproduce the embodiment of the present disclosure. However, the present disclosure may be implemented in various forms, and is not limited to embodiments described herein.

### Example 1

After a precursor having a composition of Ni_{0.8}Co_{0.1}Mn_{0.1}O₂ was prepared, lithium hydroxide and a doping element (Ti) were added such that a proportion of Li/Me became 1.05, and sintered at 700° C. for 20 hours to prepare a cathode active material having an average particle diameter (D₅₀) of 3.34 μm and a BET specific surface area of 0.496 m2/g.

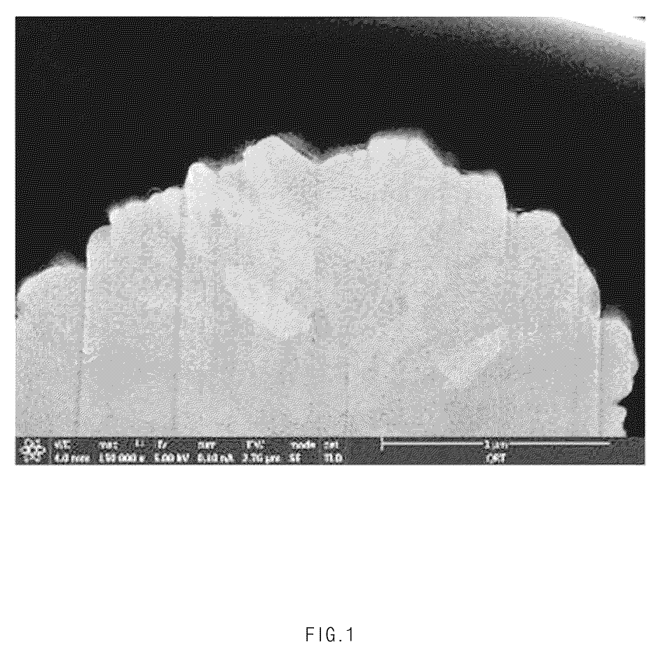

An SEM image of lithium complex metal oxide particles included in the prepared cathode active material is shown in FIG. 1. The average particle diameter was measured using a masterizer 3000 laser diffraction particle size measuring device (by Malvern panalytic), the BET specific surface area was calculated based on an adsorption amount of nitrogen gas at a liquid nitrogen temperature (77K) using TriStar II (by Micromeritics), and the SEM image was obtained using a scanning electron microscope (Helios 460F1 by FEI).

### Example 2

A cathode active material according to Example 2 was prepared in a same manner as Example 1, except that a sintering temperature was set to 750° C. The prepared cathode active material had an average particle diameter (D₅₀) of 4.01 μm and a BET specific surface area of 0.562 m²/g. The average particle diameter was measured using a masterizer 3000 laser diffraction particle size measuring device (by Malvern panalytic), and the BET specific surface area was calculated based on an adsorption amount of nitrogen gas at a liquid nitrogen temperature (77K) using TriStar II (by Micromeritics).

### Example 3

A cathode active material according to Example 3 was prepared in a same manner as Example 1, except that a sintering time was set to 30 hours. The prepared cathode active material had an average particle diameter (D₅₀) of 4.15 μm and a BET specific surface area of 0.459 m²/g. The average particle diameter was measured using a masterizer 3000 laser diffraction particle size measuring device (by Malvern panalytic), and the BET specific surface area was calculated based on an adsorption amount of nitrogen gas at a liquid nitrogen temperature (77K) using TriStar II (by Micromeritics).

### Comparative Example 1

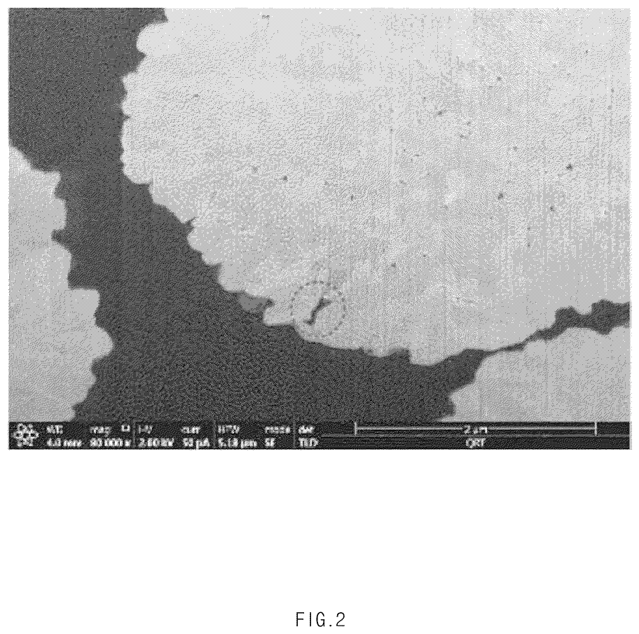

A cathode active material according to Comparative example 1 was prepared in a same manner as Example 1, except that the doping element (Ti) was not added, a sintering temperature was set to 750° C., and a sintering time was set to 40 hours. The prepared cathode active material had an average particle diameter (D₅₀) of 4.23 μm and a BET specific surface area of 0.753 m²/g. An SEM image of lithium complex metal oxide particles included in the prepared cathode active material is shown in FIG. 2. The average particle diameter was measured using a masterizer 3000 laser diffraction particle size measuring device (by Malvern panalytic), the BET specific surface area was calculated based on an adsorption amount of nitrogen gas at a liquid nitrogen temperature (77K) using TriStar II (by Micromeritics), and the SEM image was obtained using a scanning electron microscope quanta 250 FEF (by FEI).

### Comparative Example 2

A cathode active material according to Comparative example 2 was prepared in a same manner as Example 1, except that the doping element (Ti) was not added. The prepared cathode active material had an average particle diameter (D₅₀) of 3.12 μm and a BET specific surface area of 0.864 m²/g. The average particle diameter was measured using a masterizer 3000 laser diffraction particle size measuring device (by Malvern panalytic), and the BET specific surface area was calculated based on an adsorption amount of nitrogen gas at a liquid nitrogen temperature (77K) using TriStar II (by Micromeritics).

### Comparative Example 3

A cathode active material according to Comparative example 3 was prepared in a same manner as Example 1, except that a sintering temperature was set to 750° C. and a sintering time was set to 40 hours. The prepared cathode active material had an average particle diameter (D₅₀) of 4.32 μm and a BET specific surface area of 0.537 m²/g. The average particle diameter was measured using a masterizer 3000 laser diffraction particle size measuring device (by Malvern panalytic), and the BET specific surface area was calculated based on an adsorption amount of nitrogen gas at a liquid nitrogen temperature (77K) using TriStar II (by Micromeritics).

### Comparative Example 4

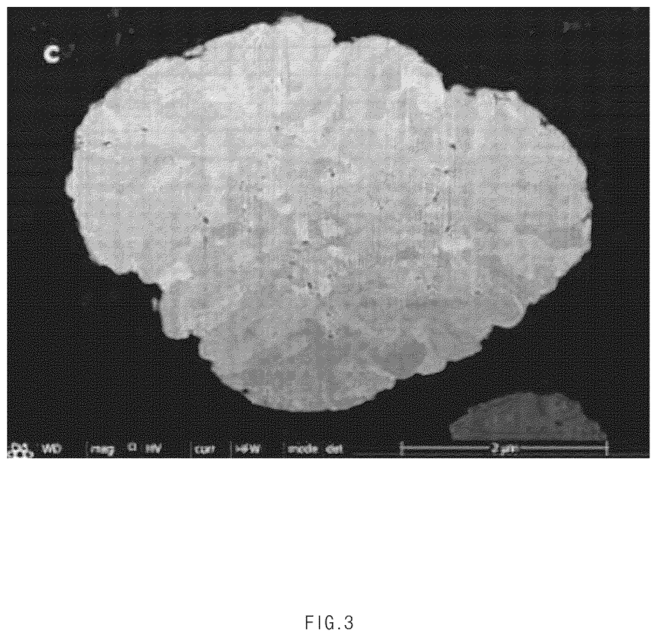

A cathode active material according to Comparative example 4 was prepared in a same manner as Example 1, except that the doping element (Ti) was not added, and a sintering time was set to 30 hours. The prepared cathode active material had an average particle diameter (D₅₀) of 3.68 μm and a BET specific surface area of 0.590 m²/g. An SEM image of lithium complex metal oxide particles included in the prepared cathode active material is shown in FIG. 3. The average particle diameter was measured using a masterizer 3000 laser diffraction particle size measuring device (by Malvern panalytic), the BET specific surface area was calculated based on an adsorption amount of nitrogen gas at a liquid nitrogen temperature (77K) using TriStar II (by Micromeritics), and the SEM image was obtained using a scanning electron microscope quanta 250 FEF (by FEI).

### Experimental Example 1

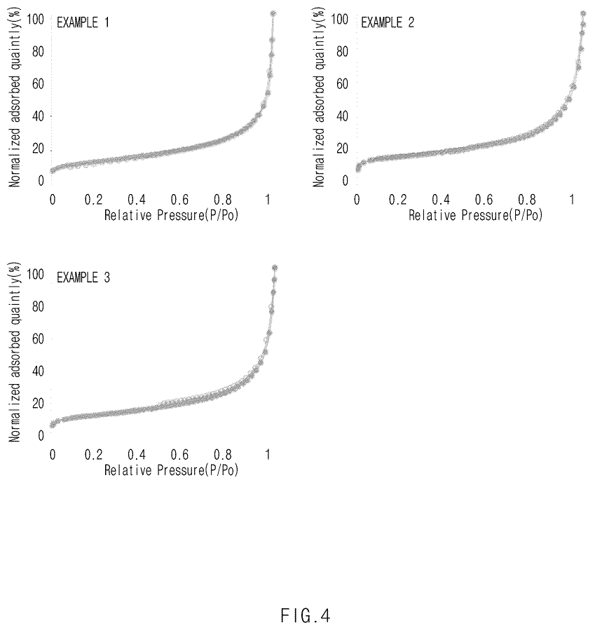

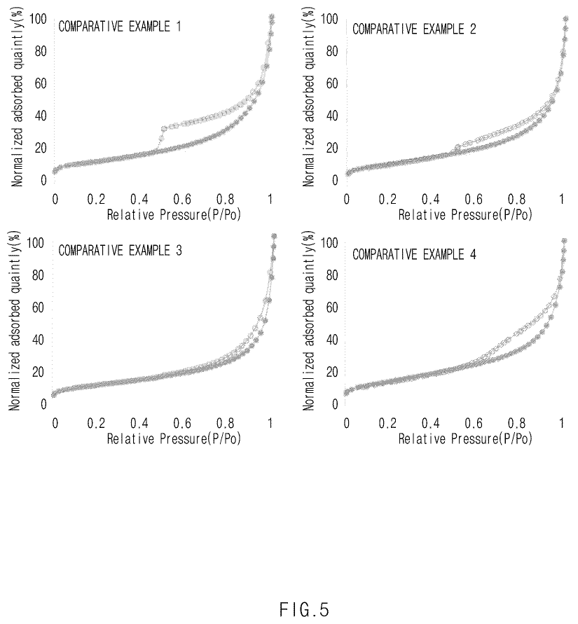

An adsorption amount of nitrogen gas and a desorption amount of nitrogen gas were measured at a liquid nitrogen temperature (77K) using TriStar II (by Micromeritics), with respect to each of cathode active materials according to examples above and comparative examples above. The adsorption isotherm and the desorption isotherm in a graph representing the normalized adsorption amount as a function of relative pressure are shown in FIGS. 4 and 5 with respect to each of cathode active materials according to the above examples and comparative examples. In addition, the maximum adsorption/desorption width (D_{H}) expressed through following Equation 3 was calculated based on the adsorption isotherm and the desorption isotherm with respect to each of cathode active materials according to the above examples and the above comparative examples, and is shown in Table 1.

The normalized adsorption amount is defined through following Equations 1 and 2, and the maximum adsorption/desorption width (D_{H}) is defined through following Equation 3.

$$Normalized adsorption amount = ( adsorption amount ( {cm}^{3} / g ) / T otal adsorption amount ( {cm}^{3} / g ) ) \times 100 \qquad Equation 1$$

$$Normalized desorption amount = ( desorption amount ( {cm}^{3} / g ) / T otal desorption amount ( {cm}^{3} / g ) ) \times 100 \qquad Equation 2$$

$${D}_{H} = max ( {Q}_{Des} - {Q}_{Abs} ) \qquad Equation 3$$

wherein, Q_{Des} is a normalized adsorption amount of the adsorption isotherm, Q_{Abs} is a normalized adsorption amount of the desorption isotherm, and max(Q_{Des}−Q_{Abs}) is a maximum difference value between the normalized adsorption amount of the adsorption isotherm and the normalized adsorption amount of the desorption isotherm, which are calculated based on the same relative pressure.

Referring to FIGS. 4 and 5, it may be recognized that the adsorption isotherms and the desorption isotherms of the cathode active materials of Examples 1 to 3 had almost the same profile, and thus hysteresis was not observed, and the adsorption isotherms and the desorption isotherms of the cathode active materials of Comparative examples 1 to 4 had different profiles, and thus hysteresis was observed. This is because many more meso-pores were formed in the cathode active materials according to Comparative examples 1 to 4, as compared to cathode active materials according to Examples 1 to 3

### Experimental Example 2

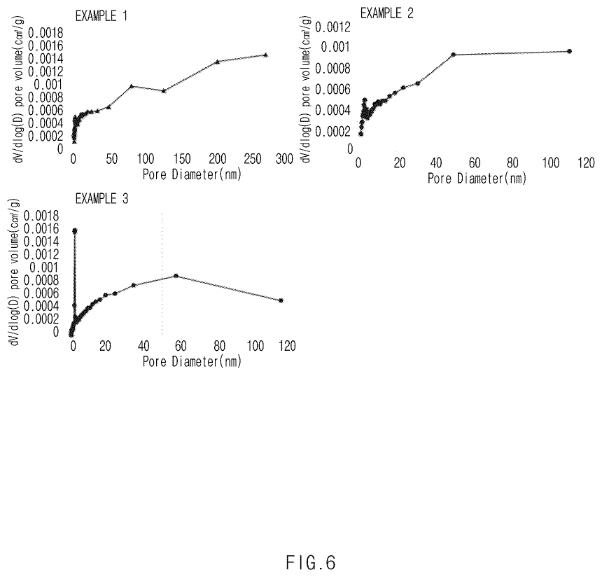

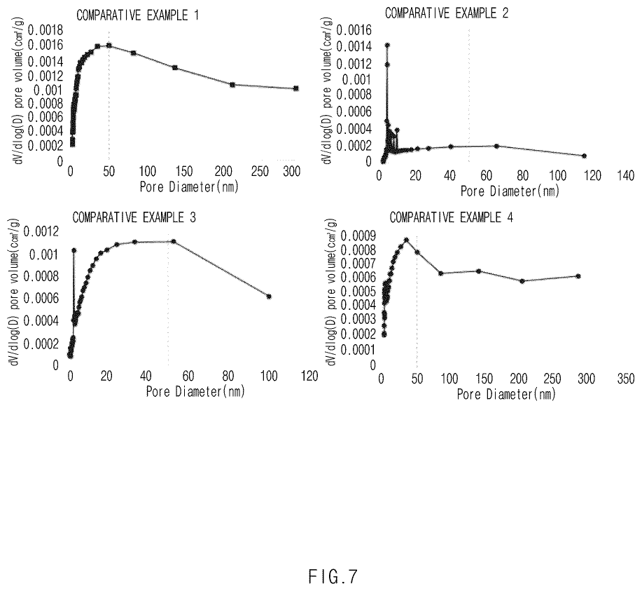

The pore diameter D (nm) and the pore volume V (cm³/g) were calculated using MicroActive 4.00 (by Micromeritics), and a Faas Correction model (by Harkins and Jura) and the graphs representing pore volume distribution as a function of a pore diameter are shown in FIGS. 6 and 7. The pore volume distribution is defined by following Equation 4.

$$pore volume distribution = \frac{dV}{d log ( D )} \qquad Equation 4$$

wherein d log(D) is a minute change in the log value of the pore diameter (D), and dV is a minute volume change of the pores corresponding to the pore diameter (D).

Referring to FIGS. 6 and 7, it may be recognized that the graphs representing pore volume distribution as a function of a pore diameter is mainly upward to the right with respect to the cathode active materials according to Examples 1 and 2. Referring to the graphs representing pore volume distribution as a function of the pore diameter with respect to the cathode active materials according to Example 3 and Comparative examples 1 to 4, it may be recognized that the pore volume distribution graphs is mainly upward to the right in the section having the pore diameter of less than 50 nm, and mainly downward to the right in the section having the pore diameter of greater than 50 nm.

This is because the cathode active materials according to Examples 1 and 2 are lower in the proportion of the micro-pores having a diameter of less than 2 nm, and higher in the proportion of the macro-pores having a diameter of greater than 50 nm, as compared to the cathode active materials according to Example 3 and Comparative examples 1 to 4.

### Experimental Example 3

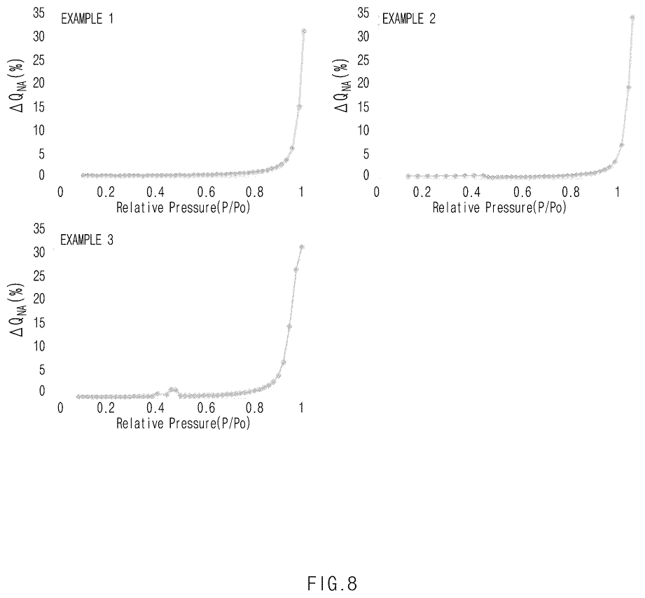

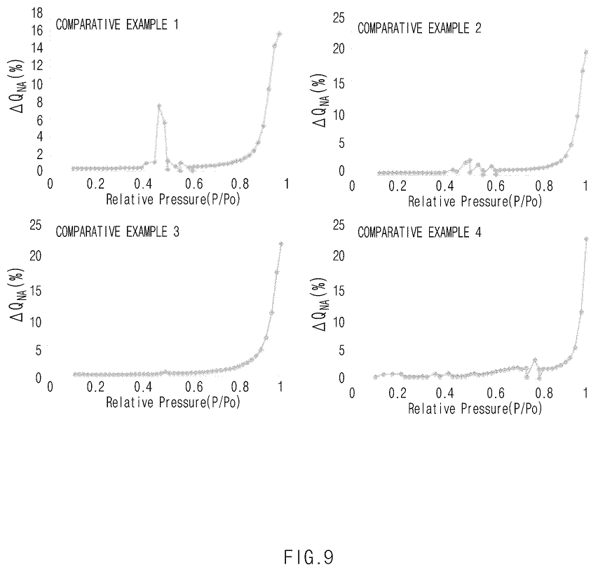

FIGS. 8 and 9 illustrate graphs representing the variation ΔQ_{NA} (%) of the normalized desorption isotherm as the function of the relative pressure according to the examples and the comparative examples. In addition, a main peak intensity of each graph illustrated in FIGS. 8 and 9 is shown in Table 1.

Referring to FIGS. 8 and 9, it may be recognized that a peak was not observed in the graph representing the variation ΔQ_{NA} (%) of the desorption isotherm as the function of the relative pressure according to Examples 1 and 2, but a peak was observed in the graph representing the variation ΔQ_{NA} (%) of the desorption isotherm as the function of the relative pressure according to Example 3 and Comparative examples 1 to 4. This is because many more closed-pores were formed in the cathode active materials according to Example 3 and Comparative examples 1 to 4, as compared to cathode active materials according to Examples 1 to 2

### Experimental Example 4—Capacity Retention

All solid state batteries having a stack structure including a cathode active material layer, a solid electrolyte layer, and an anode active material layer are stacked on each other, were manufactured by using the cathode active materials according to Examples 1 to 3 and Comparative examples 1 to 4. The same ingredient, the same content, and the same manufacturing method were employed with respect to each layer forming each all solid state battery manufactured using the cathode active materials according to Examples 1 to 3, and Comparative examples 1 to 4.

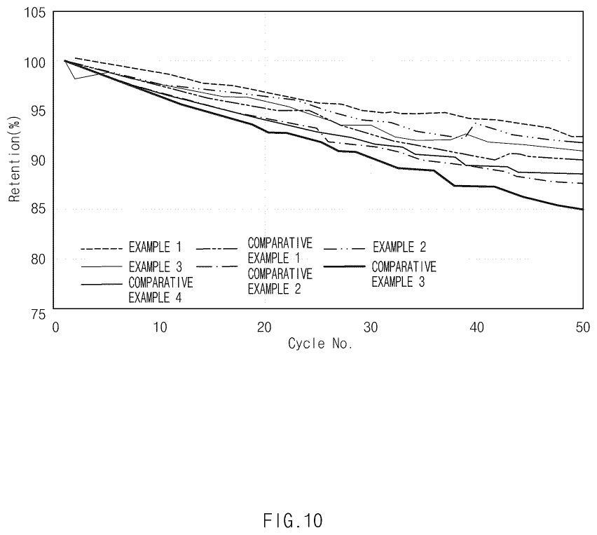

When a charging operation is performed until 4.25 V at a current density of 0.5 C in a CC-CV mode under 25° C., and a discharging operation is performed until 2.5 V at a current density of 0.5 C, in one cycle, a capacity retention (%) measured per cycle was measured with respect to the all solid state battery according to Examples and Comparative examples above, and the measure result is illustrated in FIG. 10. In addition, a capacity retention corresponding to a 50^{th} cycle is shown in Table 1.

TABLE 1

| | | | Peak | Capacity | Capacity |
|---|---|---|---|---|---|
| | D₅₀ | BET | intensity | retention | retention |
| | (μm) | (m²/g) | (ΔQ_{NA}, %) | (D_{H}) | (@50^{th} cycle) |
| Example 1 | 3.34 | 0.496 | — | 0.3 | 92.5 |
| Example 2 | 4.01 | 0.562 | — | 0.2 | 91.7 |
| Example 3 | 4.15 | 0.459 | 1.18 | 0.5 | 91.0 |
| Comparing | 4.23 | 0.753 | 7.57 | 1.4 | 89.8 |
| example 1 | | | | | |
| Comparing | 3.12 | 0.864 | 2.37 | 0.8 | 87.5 |
| example 2 | | | | | |
| Comparing | 4.32 | 0.537 | 0.47 | 0.7 | 88.4 |
| example 3 | | | | | |
| Comparing | 3.68 | 0.590 | 3.05 | 1.6 | 85.0 |
| example 4 | | | | | |

Referring to Table 1, it may be recognized that an excellent capacity retention was exhibited in an all solid state battery including the cathode active materials according to Examples 1 to 3 satisfying the maximum adsorption/desorption width (D_{H}) range, as compared to an all solid state battery including cathode active materials according to Comparative examples 1 to 4 which failed to satisfy the desired closed pore characteristic.

In addition, it may be recognized that the more excellent capacity retention was exhibited in the all solid state battery including the cathode active materials according to Examples 1 and 2 in which the maximum adsorption/desorption width (D_{H}) range was satisfied and a peak was not observed in the graph representing the variation ΔQ_{NA} (%) of the normalized desorption isotherm as the function of the relative pressure, as compared to the all solid state battery including the cathode active material according to Example 3 in which the peak was observed in the graph representing the variation ΔQ_{NA} (%) of the normalized desorption isotherm as the function of the relative pressure.

Referring to FIGS. 1-3, it may be recognized that many more closed pores were observed in the cathode active materials according to Comparative examples 1 and 4, as compared to the cathode active material according to Example 1 in which a closed pore is hardly observed.

As described above, according to an example of the present disclosure, the cathode active material as the content distribution of micro-pores, meso-pores, and macro-pores, and the content of closed pores are controlled, thereby improving the battery lifespan characteristic.

Hereinabove, although the present disclosure has been described with reference to examples and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A cathode active material comprising:
a lithium complex metal oxide, wherein the cathode active material is defined by a relative pressure relative to a saturated vapor pressure (P0) of the cathode active material and an adsorption isotherm and a desorption isotherm in a normalized adsorption/desorption amount graph represented by Equations 1 and 2 below, and a maximum adsorption/desorption width (D_{H}) represented by Equation 3 below:
$$Normalized adsorption amount = ( adsorption amount ( {cm}^{3} / g ) / total adsorption amount ( {cm}^{3} / g ) ) \times 100 \qquad Equation 1$$
$$Normalized desorption amount = ( desorption amount ( {cm}^{3} / g ) / total desorption amount ( {cm}^{3} / g ) ) \times 100 \qquad Equation 2$$
$${D}_{H} = max ( {Q}_{Des} - {Q}_{Abs} ) \qquad Equation 3$$
wherein Q_{Des} is a normalized adsorption amount of the adsorption isotherm, Q_{Abs} is a normalized adsorption amount of the desorption isotherm, and max(Q_{Des}−Q_{Abs}) is a maximum difference value between the normalized adsorption amount of the adsorption isotherm and the normalized adsorption amount of the desorption isotherm, which are calculated based on a same relative pressure, and
wherein the maximum adsorption/desorption width (D_{H}) is at most 0.6.

2. The cathode active material of claim 1, wherein a hysteresis defined by the adsorption isotherm and the desorption isotherm is not observed.

3. The cathode active material of claim 1, wherein the lithium complex metal oxide includes:
a micro-pore having a diameter of less than 2 nm;
a meso-pore having a diameter in a range from 2 nm to 50 nm; and
a macro-pore having a diameter greater than 50 nm.

4. The cathode active material of claim 3, wherein a pore volume distribution value of pores corresponding to the micro-pore and the meso-pore is smaller than a pore volume distribution value of pores corresponding to the macro-pore.

5. The cathode active material of claim 1, wherein a peak is not observed in a graph of the relative pressure and a variation ΔQ_{NA} (%) of the desorption isotherm.

6. The cathode active material of claim 1 further comprising a coating layer surrounding the lithium complex metal oxide.

7. The cathode active material of claim 6, wherein the coating layer is boron or LiNbO.

8. The cathode active material of claim 1, wherein the cathode active material has an average particle diameter in a range of 1 μm to 7 μm.

9. A cathode comprising the cathode active material according to claim 1.

10. An all solid state battery including the cathode according to claim 9, further comprising:
a solid electrolyte layer; and
an anode.

11. The all solid state battery of claim 10, wherein the solid electrolyte layer includes a sulfide-based solid electrolyte.

12. The all solid state battery of claim 10, further comprising an anode current collector, an anode active material layer, a cathode active material layer, and a cathode current collector.

13. The all solid state battery of claim 12, wherein the anode current collector, the anode active material layer, the solid electrolyte layer, the cathode active material layer, and the cathode current collector form a stacked structure.

14. The all solid state battery of claim 13, wherein the anode current collector is Ni, Cu, stainless steel, or any combination thereof.
